(19) United States
(12) Patent Application Publication
(10) Pub. No.: US 2010/0278337 A1
(43) Pub. Date: Nov. 4, 2010

(54) Encryption-Based Location Masking

(76) Inventors: Brandon Pliska, San Diego, CA (US); Gregory Lionel Bown, Vista, CA (US); Leonard Lee Magill, San Diego, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/433,798

(22) Filed: Apr. 30, 2009

(51) Int. Cl. H04N 7/167

(52) U.S. Cl. 380/200

(57) ABSTRACT

The subject matter disclosed herein provides methods and apparatus, including computer program products, for masking locations, such as uniform resource locators. In one aspect, there is provided a computer-implemented method. The method may include receiving one or more blocks; inserting one or more characters into at least one of the blocks to fill the block to a predetermined block size; and encrypting the one or more blocks, the encryption of the first block using an initialization vector that does not result in a shift of the first block when processed. Related apparatus, systems, methods, and articles are also described.

### FIELD

The subject matter disclosed herein relates encryption.

### BACKGROUND

Video players have become commonplace, allowing users to access video content on websites. For example, each day millions of users access websites, such as You Tube, MySpace, and the like, with a web browser including a plug-in (e.g., a Flash video player plug-in) to access information (also referred to as content). However, these websites use traditional, Internet advertising, relying on, among other things, simple ad placement on a webpage and so-called “sponsored links” provided with search results.

### SUMMARY

The subject matter disclosed herein provides methods and apparatus, including computer program products, for video players configured to include an embedded purchase feature.

In one aspect, there is provided a computer-implemented method. The method may provide video content to a video player including a buy mechanism embedded within the video player. The buy mechanism may be configured to enable a selection of the buy mechanism to make a purchase. The method may also include receiving an indication representative of a purchase being made using the buy mechanism.

In one aspect, there is provided a computer-implemented method. The method may include receiving one or more blocks; inserting one or more characters into at least one of the blocks to fill the block to a predetermined block size; and encrypting the one or more blocks, the encryption of the first block using an initialization vector that does not result in a shift of the first block when processed with an exclusive OR.

Articles are also described that comprise a computer-readable medium (e.g., tangibly embodied machine-readable medium) operable to cause one or more machines to result in operations described herein. Similarly, a system (e.g., a computer) is described that may include a processor and a memory coupled to the processor. The memory may include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

In the drawings,

FIG. 1 shows a block diagram of a system 100 for providing a video player embedded with a buy mechanism;

FIG. 2A depicts a process for purchasing using the video player embedded with the buy mechanism;

FIG. 2B depicts an example webpage including the client video player with the embedded buy icon;

FIG. 2C depicts a webpage generated to allow registration;

FIG. 2D depicts a webpage provided to a user interface at a website to allow the website to register as an affiliate;

FIG. 2E depicts webpages 284A generated after the buy icon is selected to allow a user to confirm that a purchase has been made;

FIG. 3 depicts a process 300 for making a purchase using the video player embedded with a buy mechanism;

FIG. 4 depicts another process 400 for making a purchase using the video player embedded with a buy mechanism;

FIG. 5 depicts an example implementation of a delivery server 110;

FIG. 6 depicts an encryption process 600; and

FIG. 7 depicts an example of an encryption module 514 configured in accordance with process 600.

Like reference symbols in the various drawings indicate like elements.

### DETAILED DESCRIPTION

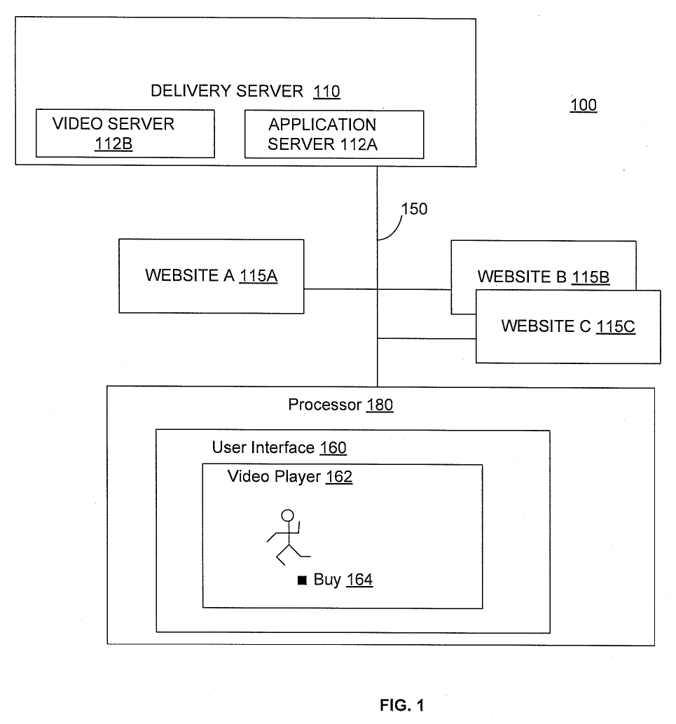

FIG. 1 depicts a block diagram of a system 100 including a delivery server 110, one or more websites 115A-C, and a processor 180, all of which are coupled by a network 150 (e.g., the Internet).

The delivery server 110 may be implemented as one or more processors, such as computers, blades, servers, and the like. The delivery server 110 may be accessible via the Internet. Moreover, the delivery server 110 may also include an application server 112A (including an application programming interface (API) for controlling the delivery of (and/or the access to) content provided by a video server 112B, which delivers content (e.g., video, music, or any other information) to a video player configured with an embedded buy mechanism (which is described further below). Although the video server 112B is depicted at delivery server 110, in some implementations the video server 112B is at one or more other locations. For example, the video server 112B may be provided by a content delivery network.

The video server 112B may be configured to provide data (e.g., a stream of video) to a client video player, such as a client video player 162 (which is described further below). The data including the stream of video may be formatted in a variety of formats. For example, the video server 112B may be implemented to operate with a client video player using the Flash format. In this example, the video server 112B communicates with one or more client video players, such as client video player 162 via a transport control protocol (TCP) connection using hypertext transport protocol (HTTP) calls and the real time messaging protocol (RTMP). Specifically, a request to serve a video stream from a client video player is handled by the video server 112B (e.g., an application instance operating within a virtual host, or machine, at distribution system 110), and the video stream may be data in a format, such as FLV files (Flash Video Files). FLV refers to a binary file format providing bit mapped video, although other formats may be used as well.

The delivery server 110 may also include a login registration module to register a user of the video player and assign privileges (e.g., what the user is authorized to view, purchase, etc.). Registration by a user making a purchase at client video player may include providing one or more of the following: an identity (e.g., a name, a password, etc.), an address, a credit card number, and the like.

The websites 115A-C may be implemented as one or more processors accessible via the Internet and serving webpages, when accessed by a user interface, such as a web browser.

The processor 180 may be implemented as any type of processor, such as a computer, a mobile device (e.g., smart phone, mobile phone, wireless computer), and the like, with wired and/or wireless connectivity to network 150. The processor 180 may further include a user interface 160, which further includes a client video player 162 with an embedded purchase feature (labeled buy 164). The user interface 160 may be implemented as any mechanism to provide an interface to a user. In some cases, the user interface 160 is implemented as a web browser (e.g., Microsoft Internet Explorer), although other types of browsers and user interfaces may be used as well. Moreover, the user interface 160 may include the client video player 162 as a plug-in (e.g., a computer-executed program interacting with a host browser application). In some implementations, the client video player 162 is configured as a Flash client configured to operate with the video server 112B described above, although formats other than Flash may be used as well.

In some implementations, the one or more websites 115A-C may include a snippet of code (also referred to herein as a “code snippet”). For example, the code snippet may be included in a webpage generated by one of the websites 115A-C, in which case the code snippet would be presented at user interface 160 when the webpage is accessed. The code snippet may have originated at delivery server 110. For example, an administrator of website 115A may cut (e.g., copied) the snippet of code, which is available via a webpage at delivery server 110, and paste the code into a webpage at website 115A. Although the snippet of code may be copied from delivery server 110, the snippet of code may be accessed and copied from other locations as well. For example, an administrator of website 115B may cut (i.e., copy) the snippet of code from another webpage at a website, such as website 115C, and then paste the snippet of code into a webpage at website 115B. This cut-and-paste process may be repeated one or more times. When that is the case, the snippet of code is disseminated in a viral manner. Regardless of how the code is disseminated, the snippet of code may be included in a webpage at a website, such that a user interface accessing the code snippet may access and select the code snippet in order to implement the client video player 162 including the embedded buy mechanism 164.

In some implementations, the snippet of code is hypertext markup language (HTML). In this example, the HTML, when selected by a user interface 160, may redirect the browser to delivery server 110 and/or video server 112B. Alternatively, the snippet of code may include embedded code, such as JavaScript, which, when executed, provides client video player 162. An example of the snippet of code is as follows:

<embed src=‘https://beta.youreeeka.com/players/hp.swf’
flashvars=‘sku=0000001278620a&amp;embedState=basic&amp;autoplay=
false&amp;protocol=http&amp;sub_domain=dev.service&amp;format=
flv&amp;affiliate_id=eccbc87e’ type=‘application/x-shockwave-flash’
allowscriptaccess=‘always’ allowfullscreen=‘true’ width=‘648’
height=‘364’ name=‘yka_player’ wmode=‘transparent’></embed>

In the above code snippet, the website hosting the snippet is registered as a so-called “affiliate” at delivery server 110. In this example, the affiliate is identified using an affiliate identifier (e.g., eccbc87e) provided to the affiliate by the delivery server 110, so that whenever a user selects the link, the delivery server 110 recognizes the affiliate identifier (e.g., to allocate any revenue from a purchase if the user selecting the link purchases a product or a service associated with the link, as described further below).

Although the above code snippet is depicted as embedded code, the code snippet may be a direct link, an example of which is as follows:

<a href=‘http://dev.account.youreeeka.com/player/0000001278620a/
eccbc87e’ target=‘_blank’><img src=‘http://static.youreeeka.com/
ronmar/products/icm_14/images/icm_14.jpg’
border=‘0’/></a>.

The code snippet may also be implemented as a pop up link, an example of which is as follows:

<script type=‘text/javascript’>function youreeeka_pop(url){var
width=920, height=620, x=(screen.width−width)/2, y=(screen.height−
height)/2;win = window.open(url, ‘pop up’, ‘scrollbars=1,
menubar=0,resizeable=1, width=‘+width+’,height=
‘+height+’,status=1’);win.moveTo(x,y);win.window.focus( );}
</script><a href=‘#’ onclick=‘youreeeka_pop
(“http://dev.account.youreeeka.com/player/0000001278620a/eccbc87e”)’>
<img src=‘http://static.youreeeka.com/ronmar/products/icm_14/
images/icm_14.jpg’ border=‘0’/></a>.

In some implementations, the user interface 160 accesses a webpage at a website, such as one of the websites 115A-C. The user interface 160 may be used to select the snippet of code. When this is the case, video server 112B may provide content to the client video player 162. For example, the content may include data (e.g., media, video, etc.), such as a video of a golf lesson or a preview of that video. At some point during the presentation of the video content at client video player 162, the user interface 160 may also present the buy icon 164, which is embedded in (e.g., included within) the client video player 162. The buy icon 164 may be selected via user interface 160 (e.g., by clicking icon 164) to purchase the video content. Specifically, in the case of a preview of the video content, the buy 164 selection continues the presentation of the golf lesson video. The buy selection 164 may also represent a purchase of a product or a service. Continuing with the golf example, the purchase may correspond to a purchase of a golf accessory, such as a golf club or a golf lesson. Although the above example describes the content originating from delivery server 110, in some implementations, the video content may be stored and thus provided by another website. When this is the case, an instance of the video server 112B may be located at that other website.

When buy icon 164 is selected, a purchase is executed. If the user is registered at delivery server 110, the buy selection 164 may result in the purchased item being processed at delivery server 110 with little or no interaction with the user interface (or the user at user interface). For example, a user may have preregistered at delivery server 110 by providing a user identifier, a password, credit card information, and a delivery address, so that the buy 164 selection results in the delivery server 110 executing a purchase (e.g., of the video delivered to client video player and/or a golf club delivered to the delivery address stored at delivery server 110). In the case of a video purchase, the delivery server 110 thus handles (e.g., controls) delivery of the video content to the client video player 162 and other functions associated with the purchase. In the case of purchasing goods or services, the delivery server 110 may also initiate the delivery of the purchased good or service, track the delivery, etc.

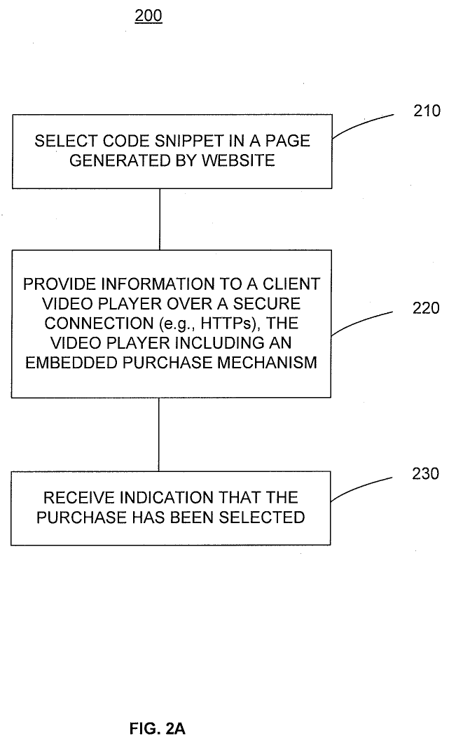

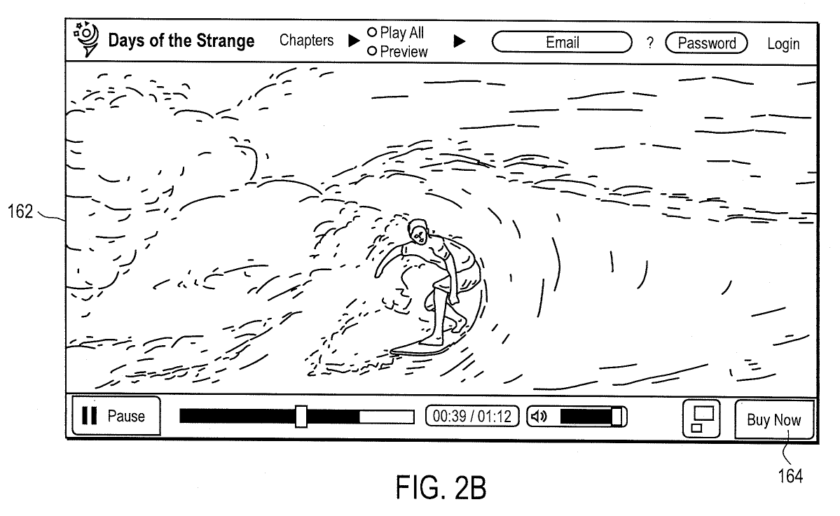

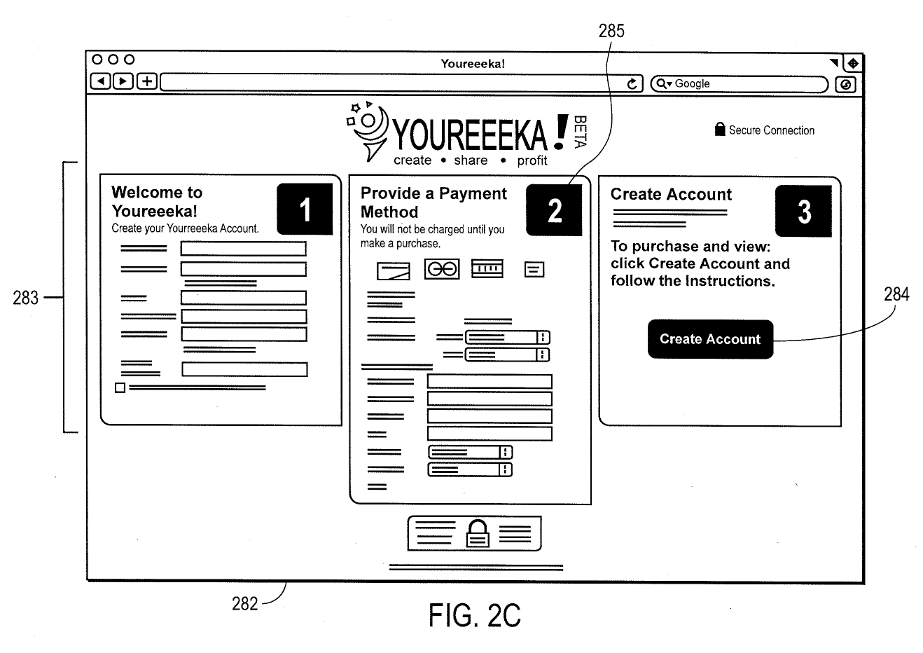

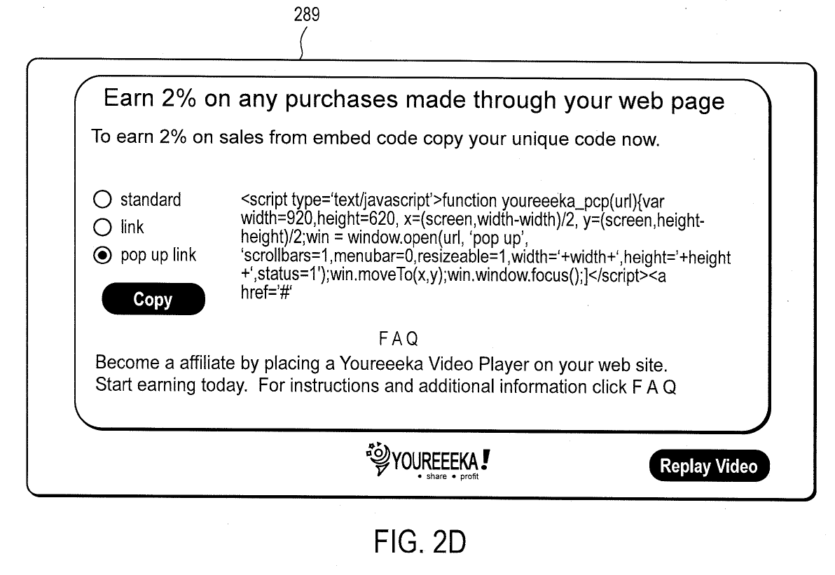

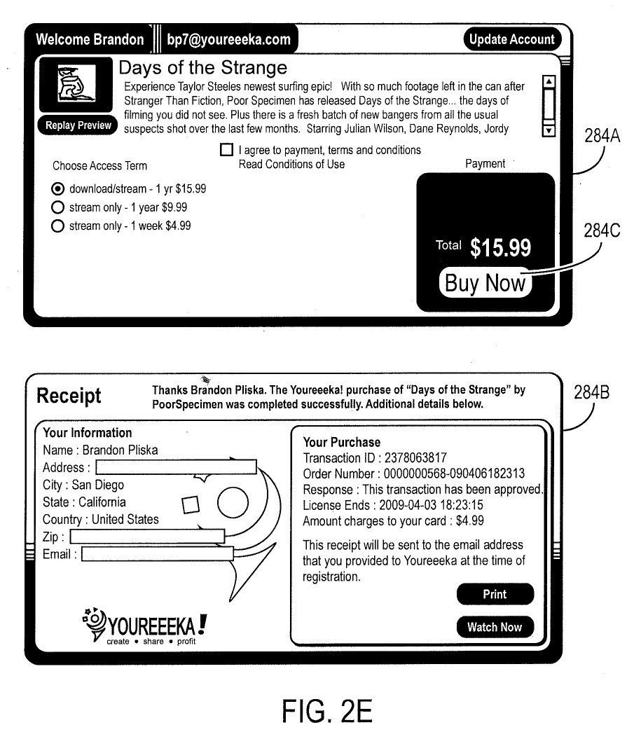

FIG. 2A depicts a process 200 for providing a snippet of code, which may be used to deliver video content to a video player including an embedded purchase feature.

At 210, the snippet of code is included in a webpage at a website. As noted above, the snippet of code may be copied from delivery server 110 and copied into a webpage at a website, such as website 115A. Moreover, the website 115A may register with delivery server 110, such that any purchases made via the webpage including the code snippet is credited to website 115A. For example, the website 115A may be assigned an affiliate identifier, so that activity (e.g., initialization, login, purchase, etc.) made via the snippet of code is tracked and, if a purchase is made, a credit may be provided to the website 115A. If another website, such as website 115B, includes the snippet of code but copies that code from a source other than delivery server 110, the website 115B may still register with delivery server 110 to receiver an affiliate identifier and thus allow credits to website 115B as purchases are made at the client video player 162 accessing website 115B (and, in particular, the webpage including the code snippet).

In some implementations, the snippet of code is configured to allow viral dissemination to any webpage, although the webpage including the snippet of code may also be presented in other ways as well (e.g., email, social networking, etc.).

Moreover, the credit allocation to a website may be in the form of an amount (e.g., a dollar amount). For example, if a purchase is made at buy icon 164 in a transaction made via website 115B, the delivery server 110 may debit the credit card account of the user making the purchase via the client video player 162. A portion of the proceeds from the purchase may be credited to delivery server 110, and a portion may be credited, in this example, to website 115B based on the affiliate identifier.

At 220, a stream of information may be provided from a video server to a client video player. The stream may include information, including video content, webpages (also referred to as pages), etc. The video player presenting the content may be configured with an embedded buy 164 mechanism to allow a user of the client video player 162 to make a purchase by accessing the buy icon 164. The video server 112B may provide the information via a secure connection, such as a HTTPs (hypertext transport protocol secure) connection, to the client video player 162.

At 230, an indication is received. The indication represents that a purchase has been selected. For example, at client video player 162, the selection of the buy icon 164 may be made by clicking (e.g., with the mouse) the buy icon 164. The selection of buy icon 164 may result in an indication (e.g., a message or an event representing a selection) being sent, such that it is received at the delivery server 110. The received selection may result in a purchase being executed by delivery server 110.

FIG. 2B depicts an example webpage including the client video player 162 with the embedded buy icon 164.

FIG. 2C depicts a webpage 282 generated to allow registration (e.g., of a user that selects the code snippet to make a purchase or of an affiliate website hosting the code snippet) by selecting “Create Account” at 284. If registered, a user may simply login at 283 by providing, for example, a name, an email address, and/or a password.

The webpage 282 may allow the user to make a purchase (e.g., at 285 by providing payment information) after the buy icon 164 is selected. For example, after the buy icon 164 is selected, the webpage 282 is provided by delivery server 110 over a secure connection (e.g., a HTTPs connection) to user interface 160 and/or client video player 162. In this sense, client video player 162 acts as a secure proxy of a HTTPs server at delivery server 110. Moreover, the client video player 162, acting as a secure proxy, eliminates the need for the website including the snippet of code (e.g., website 115B) to provide a secure server (e.g., a HTTPs server) because the secure server is provided by the delivery server 110.

FIG. 2D depicts a webpage 289 provided to a user interface at a website to allow the website to register as an affiliate. Once registered as an affiliate, the website may include the snippet of code in a webpage at the website and receive credit when a purchase is made via the affiliate website. Webpage 289 allows the affiliate website to include the snippet of code either as a standard video player, a direct link, or as a pop up. In the example of FIG. 2D, the affiliate website earns 2% of any purchases, although other allocation schemes and amounts may be used as well.

FIG. 2E depicts webpages 284A generated after the buy icon 164 is selected to allow a user to confirm that a purchase. In this example, the type of purchase allows a selection between different licenses (e.g., download/stream 1 year, stream only, etc.), although other license types may be offered as well. In some implementations, when a user is registered with delivery server 110 to make purchases, the selection of buy icon 164 causes delivery server 110 to provide webpage 284A to confirm the purchase. In this example, the user can make a purchase with two clicks (e.g., one to select the buy icon and a second to confirm the purchase 284C). However, in some implementations, the webpage 284A is not used, and, when this is the case, the user can make a purchase with one click (e.g., one to select the buy icon 164). The web webpage 284 may also be provided by delivery server 110 over a secure connection (e.g., a HTTPs connection) to user interface 160 and/or client video player 162. Webpage 284B depicts an example of a receipt provided to further confirm that the purchase has been made.

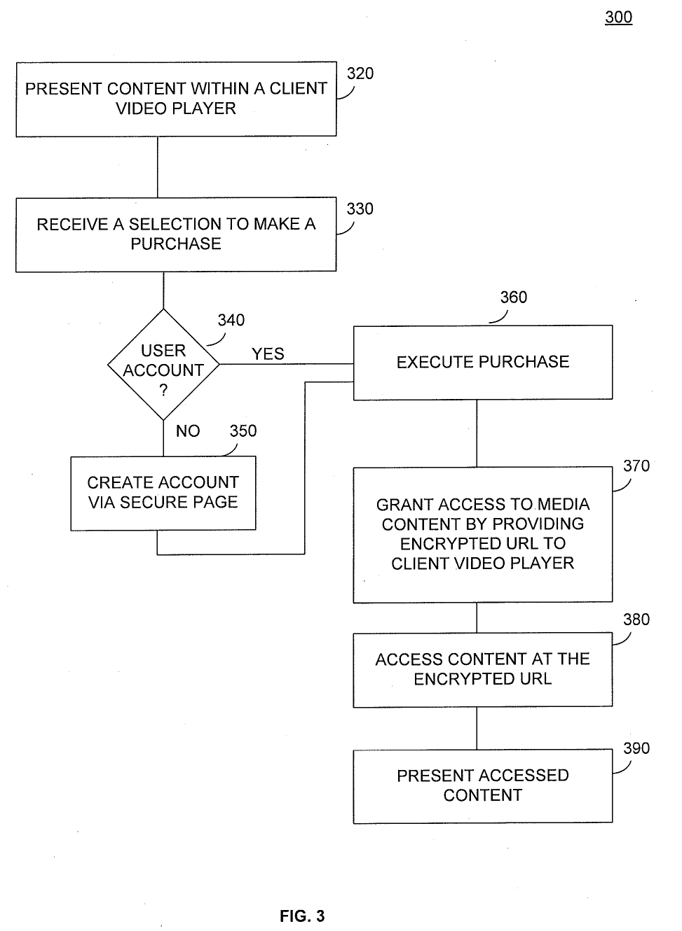

FIG. 3 depicts a process 300 for using a client video player with an embedded buy 164 mechanism.

At 320, content is presented within a video player. For example, video server 112B may provide content, such as a preview of a movie, a commercial, an infomercial, an instructional video, or any other information, to client video player 162. At any point during the presentation, the user might make a purchase using buy icon 164. For example, in the case of a movie preview, the user may be prompted to make a purchase by selecting buy 164, in which case the movie is presented at client video player 162. At the end of a commercial, an infomercial, or an instructional video, the user may be prompted to make a purchase of a good or a service by selecting the buy icon 164. Although the content is described as being sourced from delivery server 110, in some implementations, the content may be located in other locations, in which case a video server 112B would be located at that location.

At 330, a selection representative of a purchase is received. For example, the selection of buy icon 164 at the client video player 162 may result in a message being sent to delivery server 110, where an application programming interface (API) is accessed.

At 340, delivery server 110 determines whether the user at a client video player is a registered user. For example, the user at client video player 162 may be required to provide a user identifier and a password. Alternatively, metadata (e.g., cookies associated with user interface 160) may be used to determine the identity of the user of the client video player 162. In some implementations, a user is considered registered when one or more of the following is stored at delivery server 110 for the user: a user identifier, a password, a credit card number (including an expiration date), a delivery address, and the like.

At 350, an account is created when the user is not registered at delivery server 110. For example, the delivery server 110 may provide webpage 282 (FIG.2C) via a secure connection between video server 112B and client video player 112. The webpage may allow the user at client video player 162 to provide securely one or more of the following: a user identifier, a password, a credit card number (including expiration date), a delivery address, and the like. This information is stored at delivery server 110 and then the user is considered registered.

At 360, a purchase may be executed. For example, the delivery server 110 may execute the purchase by debiting a credit card (or other financial account), and initiating the delivery of the product (e.g., either via network 150 or via a delivery service, such as FedEx and the like).

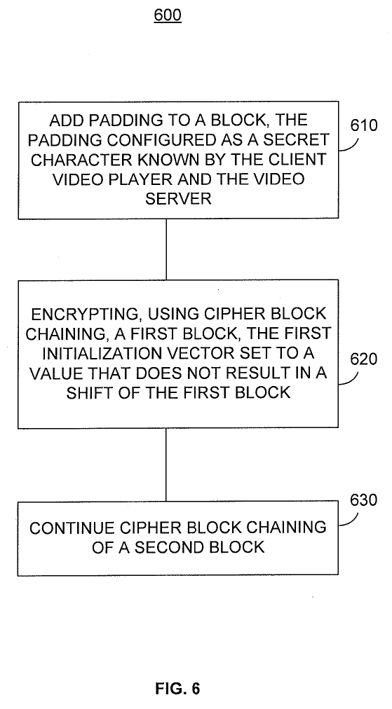

At 370, delivery server 110 grants access to the purchased content by providing, in the case of the purchase of a video, an encrypted URL (uniform resource locator) to the client video player, so that the client video player can access the video content presented at client video player 162. For example, the video content may be sourced (e.g., provided) by a third-party website, such as a content delivery network (also referred to as a media delivery network). When that is the case, the encryption of the URL prevents a user from intercepting the URL and accessing the third-party website without making a purchase. Although a variety of techniques may be used to encrypt the URL, in some implementations, the URL is encrypted using process 600 (which is described further below with respect to FIG. 6).

At 380, the video content at the location of the encrypted URL is accessed. For example, the client video player 162 may access a video server at the third-party website located at the address of the URL, which was decrypted by the client video player 162. The client video player 162 then presents the content to the user at 390.

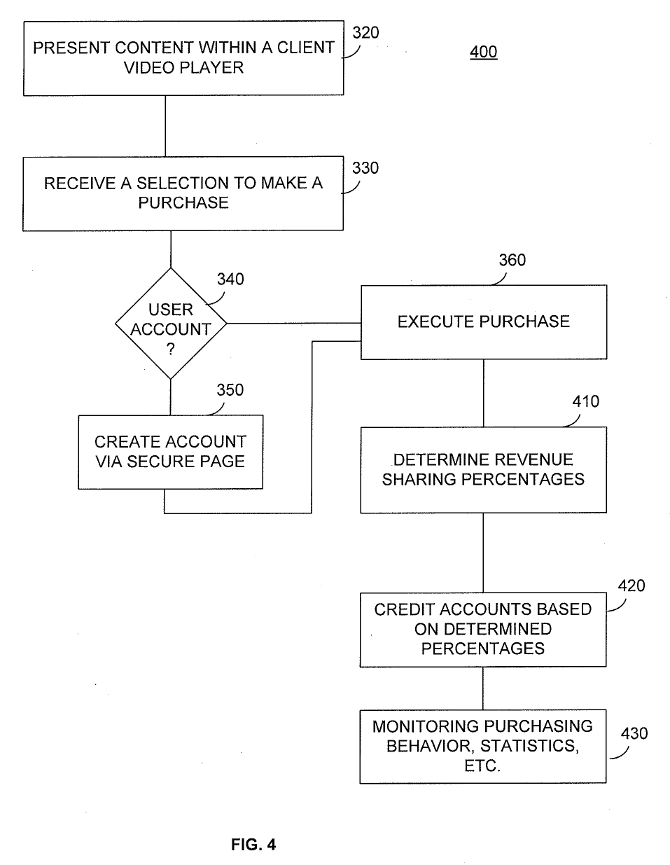

FIG. 4 depicts a process 400 for using client video player with an embedded buy 164 mechanism. Process 400 is similar to process 300 but further includes additional features as described with respect to 410-430.

The process proceeds at 320-360 as described above. At 420, however, the delivery server 110 may determine revenue sharing percentages. When a website includes the snippet of code—regardless of how that snippet of code was obtained—the delivery server 110 may allocate a portion of any revenue associated with the transaction to the website (or an entity associated with the website). For example, an administrator of website 115B may obtain the snippet of code and display that code on a webpage of the website 115B. As noted above, the snippet may be obtained virally, so that the snippet is not necessarily obtained from the delivery server 110. Once the administrator of website 115B obtains the snippet of code, the administrator may contact delivery server 110 to register as a website provider of the snippet. The registration by the website (e.g., website 115B) may include determining what type of video content may be provided to the website 115B (e.g., commercials, infomercials, previews of full-length movies, instructional videos, and the like), revenue sharing models (e.g., predetermined percentages to be allocated to the website 115B for each purchase), website account information (e.g., to credit an allocated share of revenue), and the like. The website 115B may receive an affiliate identifier when it registers with the delivery server 110 to allow the delivery server 110 to allocate, as described below at 420, any credits or debits associated with a transaction made using the code snippet (which would include the affiliate identifier).

At 420, a purchase made via the embedded buy mechanism (e.g., buy 164) may be credited to one or more entities based on the percentages allocated at 410. For example, a user accessing website 115A may view a movie preview using client video player 162, and then make a purchase by selecting buy 164 (which would purchase the entire movie that was previewed). In this example, the delivery server 110 may debit the credit card account of the user of the client video player 162 (e.g., with a $1.00 debit charge to the credit card), credit the website 115A being accessed by the user interface 160 and the plug-in client video player 162 (e.g., $0.10), credit the delivery server 110 (e.g., $0.20), and credit the content provider, such as a third-party website providing the movie (e.g., $0.70).

In the case of an infomercial, after viewing the infomercial, the user viewing the infomercial at the client video player 162 may purchase a product (e.g., with a $18.00 debit charge to the user's credit card). In this example, the delivery server 110 may allocate ⅓ of the purchase price to the website 115A being accessed by the user interface 160 and the plug-in client video player 162, ⅓ to the delivery server 110, and ⅓ to the manufacturer of the product. Although specific credit amounts, debit amounts, and types of products are noted in the previous example, other amounts, percentages, products, and services may be used as well.

Moreover, in some implementations, the code snippet includes an affiliate identifier. When this is the case, when the code snippet is selected, the delivery system 110 can allocate credits and/or debits to the website associated with that code snippet. For example, website 115B may include on a webpage the code snippet including an affiliate identifier assigned by delivery system 110 to website 115B, and website 115A may include on a webpage the code snippet including an affiliate identifier assigned to website 115A. In this example, delivery system 110 allocates credits and/or debits associated with purchase made in connection with the code snippets based on the affiliate identifiers.

At 430, delivery server 110 may monitor purchasing behavior at one or more websites 115A-C and/or one or more client video players, such as client video player 162. For example, delivery server 110 may monitor what purchases are being made using the embedded buy 164 mechanism of the client video player 162, when those purchases are being made, who is making the purchases, and the like. For example, delivery server 110 may monitor purchases being made via websites 115A-C and determine what types of products or services sell and which products and services do not. As such, delivery server 110 may adapt and thus deliver content, such as infomercials, commercials, and the like, targeted to the website.

Delivery server 110 may monitor purchases being made via client video players 162 and gather demographic information to determine what types of products or services sell and which products and services do not sell to users having different demographics. For example, if the demographics of the users indicate a Northern, cold climate, the content, such as infomercials, commercials, and the like, may include products or services more likely to elicit a purchase. As such, delivery server 110 may adapt and thus deliver content targeted to the user (or the user's demographic).

In some implementations, the delivery system 110 may track the URL of the client video player and IP address of the user of the client video player. This tracking may occur during login and when a purchase is made, although the tracking may occur at other times as well. In addition, delivery system 110 may track the actions of a user of the client video player (e.g., button presses, what is previewed, what is copied, etc.). The tracking and monitoring data may be used to generate analytical reports and cross-reference with other analytical information for website tracking and content delivery network statistics to generate a unique set of reports taking in all aspects of a user's experience from discovery to purchase.

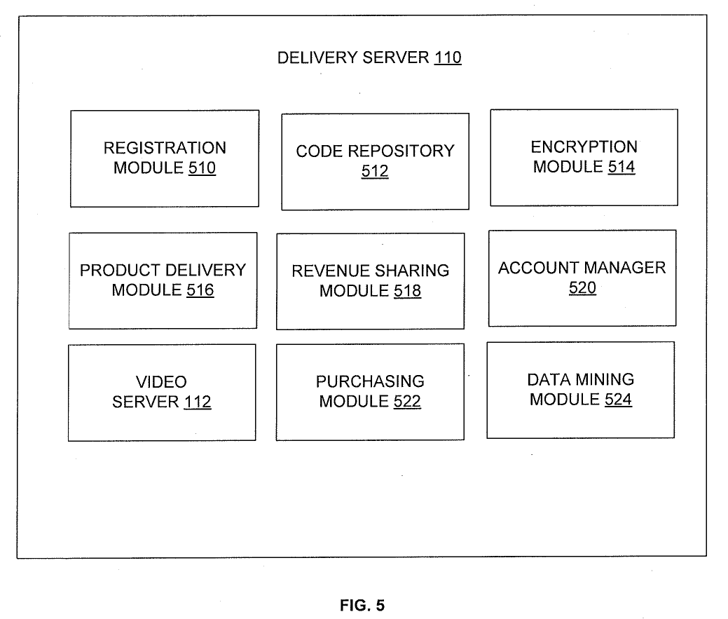

FIG. 5 depicts an example of a delivery server 110 including a registration module 510, a code repository 512, an encryption module 514, a product delivery module 516, a revenue sharing module 518, an account manager 520, a video server 112B, a purchasing module 522, and a data-mining module 524. In some implementations, the modules of delivery server 110 are implemented on at least one processor including memory.

The registration module 510 may be configured to register a user of the client video player 162 and/or register a website including the snippet of code described herein.

The code repository 512 may be configured to provide the snippets of code. For example, code repository 512 may be accessible via a webpage on the Internet, so that the snippet of code may be copied and pasted into other websites, emails, social networking sites, and the like. Although a website may obtain the snippet of code from code repository 512, the snippet of code may be obtained in other ways as well (e.g., obtained virally).

The product delivery module 516 may be configured to track the delivery of the purchased product or service. For example, if the product is an item delivered via a transport service, such as FedEx, the product delivery module 516 may generate webpages including the estimated delivery time, date, etc.

The revenue sharing module 518 may be configured to include allocations between varies entities. For example, the revenue sharing module 518 may include allocations between the websites 115A-C, content providers (e.g., providing content to the video player), product providers (e.g., providing products which can be purchased), service providers (e.g., providing services which can be purchased), and the delivery server 110.

The account manager 520 may be configured to provide a financial management function to the delivery server 110. The account manager 520 may keep track of credits, debits, etc. to various entities, such as users of the client video players, service providers, product providers, content providers, websites, and the like.

The purchasing module 522 may be configured to execute debits and/or credits to an account, such as a user's credit card account, debit account, or any other account. Moreover, the purchasing module 522 may be configured to initiate a fund transfer to service providers, product providers, content providers, websites, and the like.

The data-mining module 524 may be used to perform data mining and other monitoring activities as noted above at 430.

The delivery server 110 may also include an encryption module 514. The encryption module may be used to hide the URL provided by the delivery server 110 to the client video player 162, as described above with respect to 370. Although the encryption module 514 may use a variety of techniques to hide the URL, in some implementations, the encryption module 514 uses the process 600 of FIG. 6.

FIG. 6 depicts a process 600 for encrypting, which may be used to encrypt a URL.

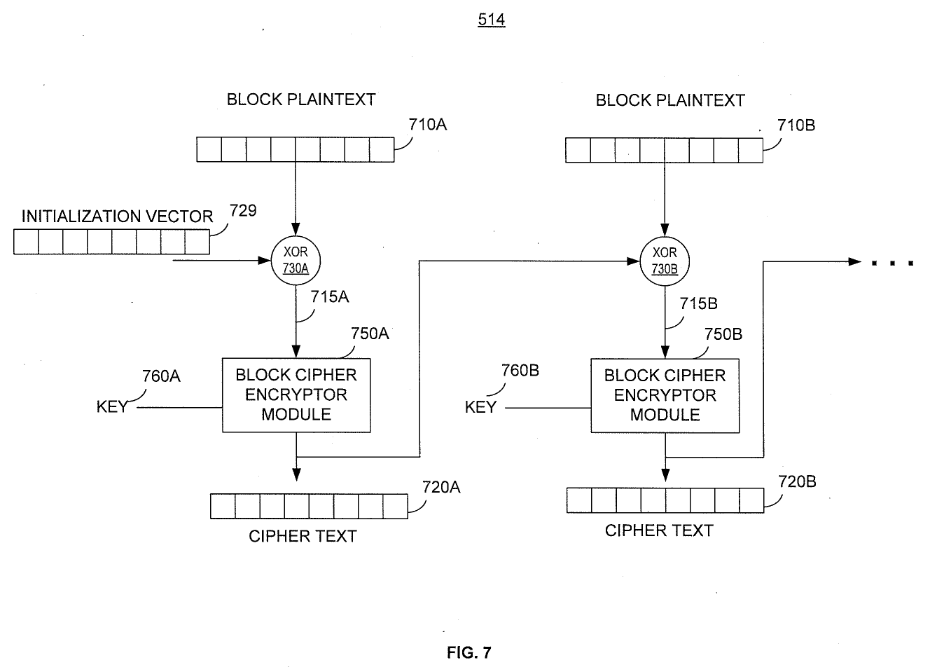

The process 600 may be implemented in encryption module 514 configured to implement cipher-block chaining (CBC), AES128, and/or other encryption techniques. FIG. 7 depicts an example of encryption, module 513 implemented using cipher-block chaining. The description of process 600 also refers to FIG. 7.

The encryption module 514 generally encrypts information in blocks (labeled blocks of plaintext 710A-B) to form encrypted text (labeled cipher text 720A-B). For example, a block may be implemented as 16 ASCII characters, each of which is 8 bits, for a total block size of 128 bits (e.g., 8×16−128). In this example, a first block is depicted as plaintext 710A, a second block is depicted as plaintext 710B, and so forth. In the case of an URL, if the URL is 240 characters, then at least two blocks 710A-B would be used, which would provide encrypted output as cipher text 720A-B.

Continuing with the 240 character URL example, the first block 710A would include the first 128 characters of the URL, and the second block 710B would include the subsequent 112 characters. In some implementations, padding may be used to fill the second block 710B to 128 characters. When this is the case, rather than using null characters (e.g., an ASCII character with a zero value) as padding, the padding may be a predetermined character known only by the client video player 162 and the delivery server 110 (or an API at the delivery server 110). In this sense, the padding is a shared secret known by the client video player 162 and the delivery server 110 (or the encryption module 514).

The first block 710A and an initialization vector 729 are processed using an excusive OR function (labeled XOR 730A). In some implementations, rather than use a random value for the initialization vector 729, the initialization vector 729 is selected, such that it does not result in an output 715A that is a shifted representation of the first block 710A. In some implementations, the initialization vector 729 is implemented as all zeroes.

The output 715A of XOR 730A is provided as an input to block cipher encyptor module 750A, which has been provided a key 760A. The block cipher encyptor module 750A may be implemented as any type of block encryption module. The output of block cipher encyptor module 750A is thus the encrypted text 720A (also referred to as cipher text).

The second block 710B is processed in a similar manner as the first block 710A. However, the second block 710B may include padding, as noted above, to fill the block 710B. Moreover, the XOR 730B processes the second block 710B and cipher text 720A (rather than an initialization vector). As such, output 715B, unlike output 715A, is a shifted representation of the second block 710B. Referring again to the URL example, the cipher text blocks 720A-B represent the encrypted URL, which is sent to the video player 162, where the URL is decrypted.

At 610, padding is added to a block. For example, encryption module 514 may add one or more characters to fill a block (e.g., 710A or 710B), when the information to be encrypted (e.g., the URL) does not completely fill the block. Returning to the above example, given a block size of 128 bits (i.e., 16 ASCII characters) and, e.g., a URL of 240 bits which needs to be encrypted, the first block 710A would not include any padding, but the second block 710B would include the final 112 characters of the URL and 16 characters of padding. Moreover, the characters used as padding are a shared secret between the delivery server 110 (or encryption module 514) and the client video player 162. Moreover, rather than using null characters (which is the typical value of the padding characters), the padding may be a predetermined character, as described above.

At 620, the first block is encrypted using, for example, cipher block chaining. The initialization vector used to encrypt the first block 710A is selected so that the first block 710A is not shifted, as noted above. For example, the first block 710A may be encrypted using cipher block chaining (which is depicted at FIG. 7). Moreover, the initialization vector 730 is determined, such that output 715A is not a shifted representation of the first block 710A.

At 630, subsequent blocks are encrypted. For example, second block 714A (as well as other blocks) may be encrypted using the cipher block chaining, without the initialization vector used at 620. Although only two portions of the chain are depicted at FIG. 7, additional portions may be used (e.g., given additional blocks of plaintext).

The video client player 162 may decrypt the encrypted URL (comprising, e.g., cipher text 720A-B) received from the encryption module 514 (e.g., using an inverse process to the one described herein). Moreover, the decryption of the URL at client video player 162 may use a variety of encryption techniques (including the inverse operation of process 600).

Although the encryption module 514 is described within the context of delivery server 110, the encryption module 514 may be used in other locations as well. Moreover, although the encryption module 514 is described in the example above as encrypting an URL, the encryption module may be used to encrypt other data as well.

To provide for interaction with a user, the subject matter described herein may be implemented on a computer having a memory, a display device (e.g., a CRT (cathode ray tube) or LCD (liquid crystal display) monitor) for displaying information to the user and a keyboard and a pointing device (e.g., a mouse or a trackball) by which the user may provide input to the computer.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. Although FIG. 1 depicts network 150, components of system 100 may be interconnected by any form or medium of communication, examples of which include point-to-point links, a bus, a local area network (“LAN”), a wide area network (“WAN”), an intranet, and the Internet.

The subject matter described herein may be embodied in systems, apparatus, methods, and/or articles depending on the desired configuration. For example, the modules and/or the processes described herein may be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “machine-readable medium” refers to any computer program product, computer-readable storage medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. Similarly, systems are also described herein that may include a processor and a memory coupled to the processor. The memory may include one or more programs that cause the processor to perform one or more of the operations described herein.

The foregoing description is intended to illustrate but not to limit the scope of the invention, which is defined by the scope of the appended claims. Other embodiments are within the scope of the following claims.

What is claimed:

1. A computer-implemented method comprising:
receiving one or more blocks;
inserting one or more characters into at least one of the blocks to fill the block to a predetermined block size; and
encrypting the one or more blocks, the encryption of the first block using an initialization vector that does not result in a shift of the first block when processed.

2. The computer-implemented method of claim 1, wherein encrypting further comprises:
using the initialization vector configured to not result in a shift of the first block when processed with an exclusive OR.

3. The computer-implemented method of claim 1, wherein receiving further comprises:
receiving a uniform resource locator configured to form the one or more blocks.

4. The computer implemented method of claim 1, wherein inserting further comprises:
using as the one or more characters a shared secret, without using a null character.

5. The computer implemented method of claim 1, wherein inserting further comprises:
using as the initialization vector all zeroes.

6. The computer implemented method of claim 1 further comprising:
decrypting the one or more blocks at a video player including an embedded buy mechanism.

7. The computer implemented method of claim 1, wherein encrypting further comprises:
encrypting, using cipher block chaining, the one or more blocks.

8. A system comprising:
a processor; and
a memory, the processor and memory configured to provide a method comprising:
receiving one or more blocks;
inserting one or more characters into at least one of the blocks to fill the block to a predetermined block size; and
encrypting the one or more blocks, the encryption of the first block using an initialization vector that does not result in a shift of the first block when processed.

9. The system of claim 8, wherein encrypting further comprises:
using the initialization vector configured to not result in a shift of the first block when processed with an exclusive OR.

10. The system of claim 8, wherein receiving further comprises:
receiving a uniform resource locator configured to form the one or more blocks.

11. The system of claim 8, wherein inserting further comprises:
using as the one or more characters a shared secret.

12. The system of claim 8, wherein inserting further comprises:
using as the initialization vector all zeroes.

13. The system of claim 8 further comprising:
decrypting the one or more blocks at a video player including an embedded buy mechanism.

14. The system of claim 8, wherein encrypting further comprises:
encrypting, using cipher block chaining, the one or more blocks.

15. A computer-readable medium including instructions to configure a processor to perform a method comprising:
a processor; and
a memory, the processor and memory configured to provide a method comprising:
a processor; and
a memory, the processor and memory configured to provide a method comprising:
receiving one or more blocks;
inserting one or more characters into at least one of the blocks to fill the block to a predetermined block size; and
encrypting the one or more blocks, the encryption of the first block using an initialization vector that does not result in a shift of the first block when processed.

16. The computer-readable medium of claim 15, wherein encrypting further comprises:
using the initialization vector configured to not result in a shift of the first block when processed with an exclusive OR.

17. The computer-readable medium of claim 15, wherein receiving further comprises:
receiving a uniform resource locator configured to form the one or more blocks.

18. The computer-readable medium of claim 15, wherein inserting further comprises:
using as the one or more characters a shared secret.

19. The computer-readable medium of claim 15, wherein inserting further comprises:
using as the initialization vector all zeroes.

20. The computer-readable medium of claim 15 further comprising:
decrypting the one or more blocks at a video player including an embedded buy mechanism.

21. The computer-readable medium of claim 15, wherein encrypting further comprises:
encrypting, using cipher block chaining, the one or more blocks.
